(19) United States
(12) Patent Application Publication
(10) Pub. No.: US 2005/0259629 A1
(43) Pub. Date: Nov. 24, 2005

(54) Adapting uplink/downlink subframe ratio in time division duplex physical frames

(76) Inventors: Neal Oliver, Florham Park, NJ (US); Oleg Gusak, Mission, KS (US); Khosrow Sohraby, Overland Park, KS (US)

Correspondence Address: INTEL CORPORATION, P.O. BOX 5326, SANTA CLARA, CA, 95056-5326, US

(21) Appl. No.: 10/853,485

(22) Filed: May 24, 2004

(51) Int. Cl. H04J 3/22

(52) U.S. Cl. 370/345

(57) ABSTRACT

Methods and systems for communicating in a wireless network using time division duplex (TDD) protocols. The ratio for uplink and downlink subframes of a physical frame may be dynamically adjusted as traffic stream requirements of the wireless network change. In certain embodiments, the wireless network is a wireless metropolitan area network (WMAN) utilizing orthogonal frequency division multiplexing (OFDM). Various specific embodiments and variations are also disclosed.

### BACKGROUND OF THE INVENTION

Due to the increasing uses for broadband communications, it is becoming more important to be able to provide high speed telecommunication services to subscribers which are relatively inexpensive as compared to existing cable and land line technologies. As a result, there has been much focus on using wireless mediums for broadband communications. Accordingly, it is desirable to improve efficiency and/or capacity for high bandwidth wireless communications.

### BRIEF DESCRIPTION OF THE DRAWING

Aspects, features and advantages of the present invention will become apparent from the following description of the invention in reference to the appended drawing in which like numerals denote like elements and in which:

FIG. 1 is block diagram of a wireless network according to one embodiment of the present invention;

FIG. 2 is a block diagram showing a frame structure according to various embodiments of the present invention;

FIG. 3 is a flow diagram detailing a process for adapting the ratio of downlink and uplink subframes according to various embodiments of the present invention;

FIG. 4 is a block diagram showing an adjusted frame structure according to various embodiments of the present invention; and

FIG. 5 is a block diagram of an example embodiment for an apparatus adapted to perform one or more of the methods of the present invention.

### DETAILED DESCRIPTION OF THE INVENTION

While the following detailed description may describe example embodiments of the present invention in relation to wireless networks utilizing Orthogonal Frequency Division Multiplexing (OFDM) modulation, the embodiments of present invention are not limited thereto and, for example, can be implemented using other modulation and/or coding schemes where suitably applicable. Further, while example embodiments are described herein in relation to wireless metropolitan area networks (WMANs), the invention is not limited thereto and can be applied to other types of wireless networks where similar advantages may be obtained. Such networks specifically include, but are not limited to, wireless local area networks (WLANs), wireless personal area networks (WPANs) and/or wireless wide area networks (WWANs).

The following inventive embodiments may be used in a variety of applications including transmitters and receivers of a radio system, although the present invention is not limited in this respect. Radio systems specifically included within the scope of the present invention include, but are not limited to, network interface cards (NICs), network adaptors, mobile stations, base stations, access points (APs), gateways, bridges, hubs and cellular radiotelephones. Further, the radio systems within the scope of the invention may include cellular radiotelephone systems, satellite systems, personal communication systems (PCS), two-way radio systems, two-way pagers, personal computers (PCs) and related peripherals, personal digital assistants (PDAs), personal computing accessories and all existing and future arising systems which may be related in nature and to which the principles of the inventive embodiments could be suitably applied.

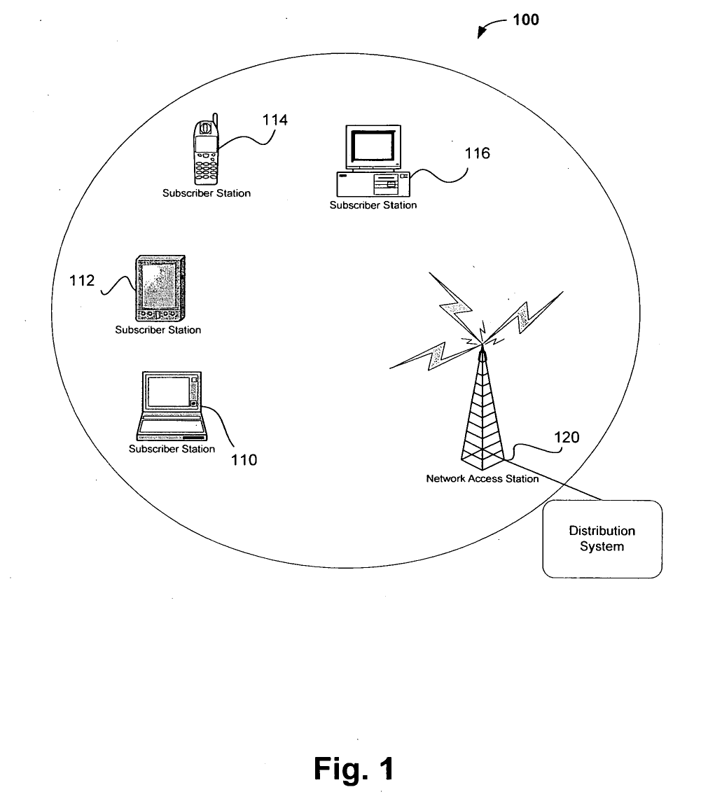

Turning to FIG. 1, a wireless communication system 100 having a time division duplex (TDD) mode according to one embodiment of the invention may include one or more subscriber stations (SS) 110, 112, 114, 116 and one or more network access stations 120 (also referred to as base stations (BS)). System 100 may be any type of wireless network such as a wireless metropolitan area network (WMAN) or wireless wide area network (WWAN) where subscriber stations 110-116 communicate with network access station 120 via an air interface.

System 100 may further include one or more other wired or additional wireless network devices as desired. In certain embodiments system 100 may use and air interface utilizing multi-carrier modulation such as OFDM, although the embodiments of the invention are not limited in this respect. OFDM works by dividing up a wideband channel into a larger number of sub-channels. By placing a subcarrier in each sub-channel, each subcarrier may be modulated separately depending on the signal interference to noise ratio (SINR) characteristics in that particular narrow portion of the band.

In operation, transmission may occur over a radio channel which may be divided into intervals of uniform duration called frames. There are many different physical layer protocols which may be used to encode data into frames. In certain example embodiments using OFDM, the physical frame may be divided into a time sequence of OFDM symbols. Each symbol may be composed of a collection of modulation symbols multiplexed in frequency (e.g., using quaternary phase shift keying (QPSK), 16-bit or 64-bit quadrature amplitude modulation (QAM)), into which data are encoded although the present invention is not limited in this respect.

The channel quality, which may be measured by the signal interference to noise ratio (SINR), may dynamically change due to changing environments (e.g., weather, obstacles between the BS and SS and/or changing distances between peers). A threshold bit error rate (BER) may be maintained by adjusting the modulation schema used to encode data into the frame. The modulation schemes used may be encoded in a data structure called a burst profile, which may be transmitted by the BS to SSs and used to determine how to decode data from the physical frame.

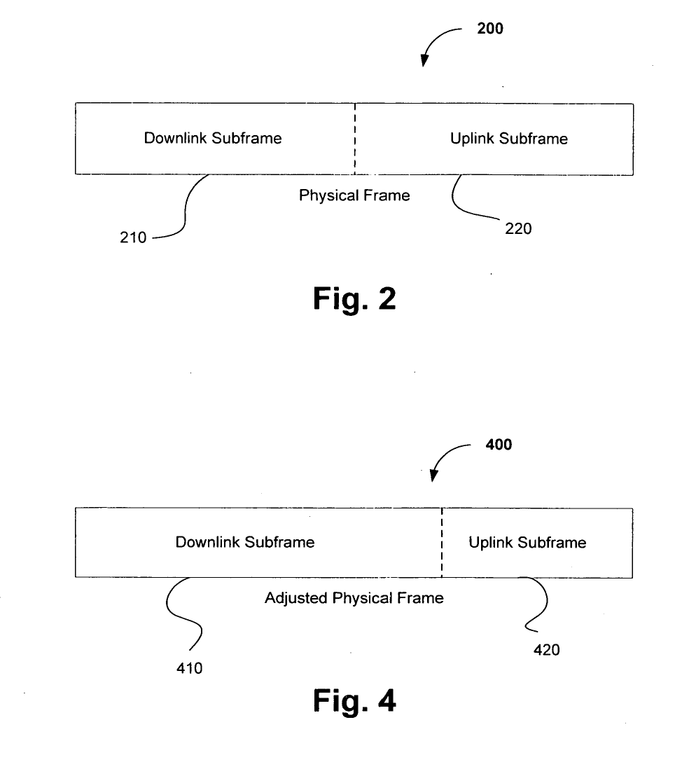

In time division duplex (TDD) mode, referring to FIG. 2, each physical frame 200 sent and received by a base station may be divided into a downlink subframe 210 and an uplink subframe 220. It is noted that additional frame components which may be present, such as guard times, are not shown. The duration or length of the physical frame 200 is typically fixed (e.g., 5 milliseconds or specified as a fixed number of OFDM symbols) for all communications in the network.

In TDD mode, a channel may carry multiple service flows of data between the BS and SSs. In certain embodiments, each service flow may include a connection ID, quality of service (QoS) class, and/or other flow specific parameters. In the downlink (i.e., from base station to subscriber station), the BS may transmit both data from the service flows and/or control messages. In various embodiments, the base station may also transmit a downlink map and/or an uplink map. The downlink map may describe to the subscriber stations where their data is to be found in the downlink subframe, and which burst profile should be used to decode it. The uplink map may describe to the subscriber stations the bandwidth and location in the uplink subframe that has been reserved for their uplink transmissions in the frame.

In the uplink (e.g. from SS to BS), the SSs may transmit packets in the regions of uplink subframe as specified in the uplink map received from the BS. These packets may contain data from service flows and control messages, including additional bandwidth requests.

The BS may therefore include a scheduler responsible for scheduling packet transmissions in the downlink and bandwidth grants for the uplink. Thus the BS may manage queues of service flow data from high-level protocols and queues of bandwidth requests received from SSs, construct the uplink and downlink maps and assemble the frame data structure which may be subsequently encoded by the physical layer.

It has been observed that information flow (e.g., service flows and/or control messaging) between subscriber stations and a corresponding base station may be asymmetric. That is, transmitted information is often greater in one of the downlink direction or the uplink direction. Accordingly, it is likely that, as in the case of frame 200 having downlink and uplink subframes 210, 220 with equal durations, either the downlink subframe 210 or uplink subframe 220 may be filled to capacity while the other subframe may not be fully utilized. Accordingly, it would be beneficial to dynamically adjust the durations (or ratio) of the downlink and uplink subframes to maximize utilization of each physical frame.

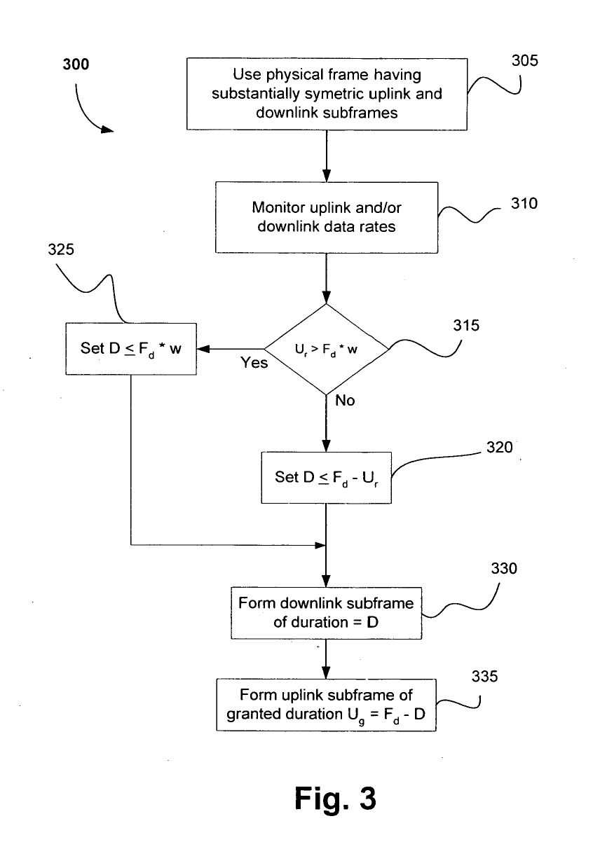

Referring to FIG. 3, a method 300 for communicating in a wireless network using time division duplex (TDD) protocols is directed to dynamically adjust durations of uplink and downlink subframes of a physical frame to reduce non-utilized space in the physical frame.

In one embodiment, method 300 may begin by transmitting or receiving 305 physical frames with equal duration uplink and downlink subframes although the inventive embodiments are not limited in this respect. During operation, the uplink and downlink data rates through the network may be monitored 310 to identify whether data flow is weighted in one direction or the other. If it is observed that data flow is asymmetric, the duration of the uplink and downlink subframes may be adjusted accordingly. For example, the duration of the downlink subframe (D) may be adjusted 320, 330 to be less than or substantially equal to the difference of the duration of the total physical frame (F_{d}) less a duration of the uplink subframe (Uᵣ) requested or required by subscriber stations.

In certain embodiments the duration of uplink and downlink subframes may alternatively or additionally be adjusted based on an average downlink data rate (w) as a percentage of a sum of total downlink and uplink data rates. In other words, adjustment may be made when the average of the downlink data rate crosses a predetermined threshold of the total data rate. In one example, if 315 the requested duration of the uplink subframe (Uᵣ) is greater than the product of the duration of the physical frame (F_{d}) and the average downlink data rate (w), then the duration of the downlink subframe (D) may be adjusted 325, 330 to be less than or equal to the product of the duration of the physical frame (F_{d}) and the average downlink data rate (w).

The uplink subframe can be granted 335 a duration (U_{g}) using the remaining duration available within the physical frame (i.e., F_{d}-D).

The following algorithm summarizes potential dynamic adjustment of subframes according to one example embodiment:
if Uᵣ>F_{d}*w, then D_{g}=F_{d}*w;
else, D_{g}=F_{d}−Uᵣ;
form the downlink subframe with duration D≦D_{g}; and
U_{g}=F_{d}−D;
where Uᵣ and U_{g} are respective required (or requested) and granted durations of the uplink subframe, D_{g} is the available or granted duration for the downlink subframe, D is duration of the downlink subframe formed, F_{d} is a duration of the physical frame and w is the average downlink data rate. It should be recognized that various modifications could be made to the foregoing algorithm and the embodiments of the present invention are not limited in this respect. For example, in one embodiment, if the requested duration of the uplink subframe (Uᵣ) is greater than ½ the frame duration (F_{d}) then the duration of the downlink subframe can be set to ½ the frame duration (e.g., F_{d}/2).

As shown in FIG. 4 the durations of downlink and uplink subframes 410, 420 can be adjusted as necessary so that substantially the entire duration of the physical frame 400 can be utilized based on the data flow trends of the network. This dynamic adjustment may preferably be made at each frame interval (i.e., every time a frame is constructed by the base station) but the embodiments of the present invention are not limited in this respect and adjustments may be made on a periodic basis, only when there is high traffic volume or otherwise as suitably desired.

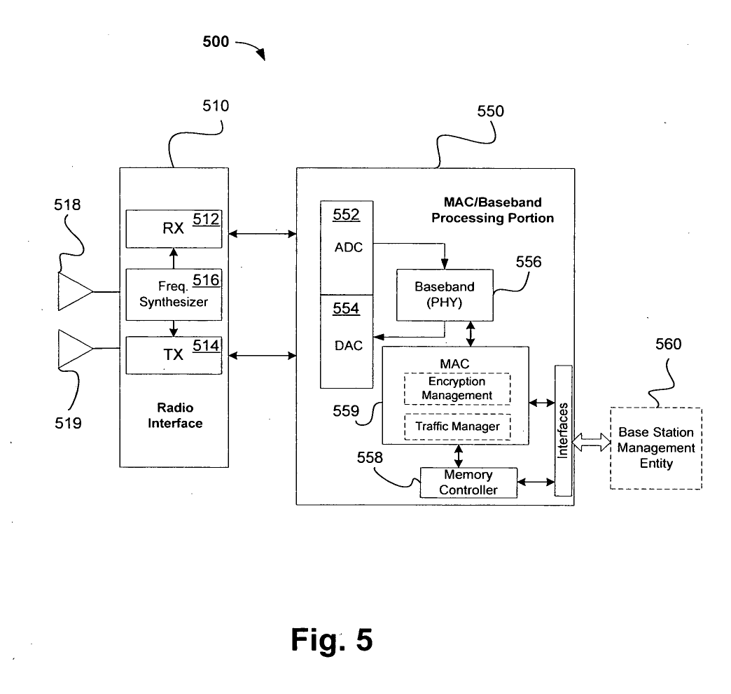

Referring to FIG. 5, an apparatus 500 for use in a wireless network may include a processing circuit 550 adapted to dynamically adjust durations of uplink and downlink subframes of a physical frame to reduce non-utilized space in the physical frame as described above. In certain embodiments, apparatus 500 may generally include a radio frequency (RF) interface 510 and a baseband and medium access controller (MAC) processor portion 550.

In one example embodiment, RF interface 510 may be any component or combination of components adapted to send and receive multi-carrier modulated signals (e.g., OFDM) although the inventive embodiments are not limited to any particular modulation scheme. RF interface may include a receiver 512, transmitter 514 and frequency synthesizer 516. Interface 510 may also include bias controls, a crystal oscillator and/or one or more antennas 518, 519 if desired. Furthermore, RF interface 510 may alternatively or additionally use external voltage-controlled oscillators (VCOs), surface acoustic wave filters, intermediate frequency (IF) filters and/or radio frequency (RF) filters as desired. Various RF interface designs and their operation are known in the art and the description thereof is therefore omitted.

In some embodiments interface 510 may be configured to be compatible with one or more of the Institute of Electrical and Electronics Engineers (IEEE) 802.16 standards specified for broadband wireless networks, although the embodiments are not limited in this respect.

Processing portion 550 may communicate with RF interface 510 to process receive/transmit signals and may include, by way of example only, an analog-to-digital converter 552 for down converting received signals, a digital to analog converter 554 for up converting signals for transmission, a baseband processor 556 for physical (PHY) link layer processing of respective receive/transmit signals, and one or more memory controllers 558 for managing read-write operations from one or more internal and/or external memories (not shown). Processing portion 550 may also include or be comprised of a processing circuit 559 for medium access control (MAC)/data link layer processing.

In certain embodiments of the present invention, MAC processing circuit 559 and/or additional circuitry may include a traffic manager which functions to dynamically adjust uplink/downlink subframe ratios and/or other scheduling and/or mapping functions as described previously. MAC processing circuit 559 may also include, if desired, encryption management functions. Alternatively or in addition, baseband processing circuit 556 may share processing for certain of these functions or perform these processes independent of MAC processing circuit 559. MAC and PHY processing may also be integrated into a single component if desired. Apparatus 500 may also include, or interface with, a station management entity 560 which may control or assist in scheduling traffic, quality of service (QoS) attributes and/or other features.

Apparatus 500 may be, for example, a wireless base station, wireless router and/or network adaptor for computing devices. Accordingly, the previously described functions and/or specific configurations of apparatus 500 could be included or omitted as suitably desired.

The components and features of apparatus 500 may be implemented using any combination of discrete circuitry, application specific integrated circuits (ASICs), logic gates and/or single chip architectures. Further, the features of apparatus 500 may be implemented using microcontrollers, programmable logic arrays and/or microprocessors or any combination of the foregoing where suitably appropriate.

It should be appreciated that the example apparatus 500 shown in the block diagram of FIG. 5 represents only one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments of the present invention.

Embodiments of the present invention may be implemented using single input single output (SISO) architectures. However, as shown in FIG. 5, certain preferred implementations may use multiple input multiple output (MIMO) architectures using multiple antennas (e.g., 518, 519; FIG. 5) for transmission and/or reception. Further, embodiments of the invention may utilize multi-carrier code division multiplexing (MC-CDMA) multi-carrier direct sequence code division multiplexing (MC-DS-CDMA) or any other existing or future arising modulation or multiplexing scheme compatible with the features of the inventive embodiments.

Unless contrary to physical possibility, the inventors envision the methods described herein: (i) may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

1. A method for communicating in a wireless network using time division duplex (TDD) protocols, the method comprising:
observing at least one of network uplink or downlink data rates; and
dynamically adjusting durations of uplink and downlink subframes of a physical frame to reduce non-utilized space in the physical frame based on the observations.

2. The method of claim 1 wherein dynamically adjusting durations comprises setting the duration of the uplink subframe to accommodate uplink requests from subscriber stations.

3. The method of claim 1 wherein dynamic adjustment is based on an average downlink data rate as a percentage of a sum of total downlink and uplink data rates.

4. The method of claim 3 wherein dynamic adjustment comprises setting a duration for the downlink subframe to be less than or equal to a product of a duration of the physical frame and the average downlink data rate when a required duration of the uplink subframe is greater than the product of the duration of the physical frame and the average downlink data rate.

5. The method of claim 1 wherein dynamic adjustment comprises setting a duration for the downlink subframe to be less than or equal to a difference of a duration of the physical frame less a required duration of the uplink subframe.

6. The method of claim 3 wherein dynamic adjustment is performed at every frame interval using the algorithm:
if Uᵣ>F_{d}*w, then D_{g}=F_{d}*w;
else, D_{g}=F_{d}−Uᵣ;
form the downlink subframe with duration D≦D_{g}; and
U_{g}=F_{d}−D;
where Uᵣ and U_{g} are respective requested and granted durations of the uplink subframe, D_{g} is a granted duration of the downlink subframe, D is a formed duration of the downlink subframe, F_{d} is a duration of the physical frame and w is the average downlink data rate.

7. The method of claim 6 wherein prior to determining the average downlink data rate, w=0.5.

8. The method of claim 1 wherein the wireless network utilizes orthogonal frequency division multiplexing (OFDM).

9. The method of claim 8 wherein the wireless network comprises a wireless metropolitan area network (WMAN).

10. The method of claim 1 wherein the method is performed by a media access controller (MAC) of a base station.

11. An apparatus for use in a wireless network, the apparatus comprising:
a processing circuit adapted to dynamically adjust durations of uplink and downlink subframes of a physical frame to reduce non-utilized space in the physical frame.

12. The apparatus of claim 11 wherein the processing circuit is further adapted to observe uplink and downlink data rates of the wireless network and wherein dynamic adjustment is based on the observations.

13. The apparatus of claim 11 wherein dynamic adjustment is based on an average downlink data rate as a percentage of a sum of total downlink and uplink data rates.

14. The apparatus of claim 13 wherein dynamic adjustment comprises setting a duration for the downlink subframe to be less than or equal to a product of a duration of the physical frame and the average downlink data rate when a requested duration for the uplink subframe is greater than the product of the duration of the physical frame and the average downlink data rate.

15. The apparatus of claim 11 wherein dynamic adjustment comprises setting a duration for the downlink subframe to be less than or equal to a difference of a duration of the physical frame less a requested duration of the uplink subframe.

16. The apparatus of claim 15 wherein dynamic adjustment further comprises setting the duration for the uplink subframe to be a duration of the physical frame less the set duration of the downlink subframe.

17. The apparatus of claim 13 wherein dynamic adjustment is performed at each frame interval using the algorithm:
if Uᵣ>F_{d}*w, then D_{g}=F_{d}*w;
else, D_{g}=F_{d}−Uᵣ;
form the downlink subframe with duration D≦D_{g}; and
U_{g}=F_{d}−D;
where Uᵣ and U_{g} are respective requested and granted durations of the uplink subframe, D_{g} is a granted duration of the downlink subframe, D is a duration of the formed downlink subframe, F_{d} is a duration of the physical frame and w is the average downlink data rate.

18. The apparatus of claim 11 further comprising:
a radio frequency (RF) interface coupled to the processing circuit.

19. The apparatus of claim 16 wherein prior to determining the average downlink data rate, w=0.5.

20. The apparatus of claim 11 wherein the wireless network comprises a wireless metropolitan area network (WMAN).

21. The apparatus of claim 11 wherein the wireless network utilizes orthogonal frequency division multiplexing (OFDM) modulation.

22. The apparatus of claim 11 wherein the processing circuit comprises a media access controller (MAC).

23. The apparatus of claim 11 wherein the apparatus comprises a base station.

24. The apparatus of claim 18 further comprising at least two antennas coupled to the RF interface to provide multiple input multiple output (MIMO) capability.

25. A system comprising:
a media access controller adapted to adjust durations of uplink and downlink subframes of a physical frame to reduce non-utilized space in the physical frame; and
at least two antennas communicatively coupled to the media access controller to facilitate multiple input multiple output (MIMO) operation.

26. The system of claim 25 wherein the media access controller is further adapted to observe uplink and downlink data rates of a wireless network and wherein dynamic adjustment is based on the observations.

27. The system of claim 25 wherein adjusting durations is based on an average downlink data rate as a percentage of a sum of total downlink and uplink data rates.

28. The system of claim 27 wherein adjusting durations of the uplink and downlink subframes comprises setting a duration for the downlink subframe to be less than or equal to a product of a duration of the physical frame and the average downlink data rate when a requested duration of the uplink subframe is greater than the product of the duration of the physical frame and the average downlink data rate.

29. The system of claim 25 wherein adjusting durations of the uplink and downlink subframes comprises setting a duration for the downlink subframe to be less than or equal to a difference of a duration of the physical frame less a requested duration of the uplink subframe.

30. The system of claim 29 wherein adjusting durations further comprises setting a duration for the uplink subframe to be a duration of the physical frame less the set duration of the downlink subframe.

31. The system of claim 25 wherein the system comprises a base station.
